(19) United States
(12) Patent Application Publication
(10) Pub. No.: US 2015/0008059 A1
(43) Pub. Date: Jan. 8, 2015

(54) DRIVE DEVICE FOR BICYCLES

(71) Applicants: Philip Douglas, Maschwanden (CH); Horst Gusterhuber, Inzell (DE)

(72) Inventors: Philip Douglas, Maschwanden (CH); Horst Gusterhuber, Inzell (DE)

(21) Appl. No.: 14/378,074

(22) PCT Filed: Feb. 7, 2013
(86) PCT No.: PCT/EP2013/052433

§ 371 Date: Aug. 11, 2014

(30) Foreign Application Priority Data
Feb. 7, 2009 (WO) PCTEP2013052433

(51) Int. Cl. B62K 25/32; B62M 6/55

(52) U.S. Cl. CPC B62K 25/32; B62M 6/55
USPC 180/206.1; 280/260

(57) ABSTRACT

The invention relates to a drive device (1) for a bicycle. The drive device (1) comprises a central housing (4), to which at least one swingarm (5, 6) is attached laterally which serves to hold a wheel (27) that is arranged such that it can rotate about a rotational axis (25). The at least one swingarm (5, 6) serves to receive at least one drive means (7, 8, 17, 18, 19).

### BACKGROUND OF THE INVENTION

1. Field of the Invention

The present invention lies in the field of drive devices for bicycles.

2. Discussion of Related Art

Until now, for all bicycle types, it has always been the case that the frame structure represented the central formative and functionally defining element. The specification of the standardized components resulted in severe creative limitation with regard to the possible frame structure. Frames must have all of the interfaces required for the function and furnishing of bicycles in order to enable the respective components to be fitted. Aside from bicycle variety in terms of form and type, most developments are usually restricted to the area of the components to be fitted (aside from the weight saving through the use of new materials). This pattern continues with regard to the integration of electric auxiliary drives. Even the manufacturers of the drive units and controllers (for example Panasonic, Bosch, Daum) known from the prior art focus primarily on their components and not on the bike as a whole. Here, the assembly of products from different manufacturers seldom leads to a harmonious whole. There are a few bicycles known from the prior art in which it has been attempted to integrate drive components into the single supporting structure of a frame. These however do not have a very well-rounded appearance and have only limited suitability for use in different bicycle structures.

EP0102942 from Steyr Daimler Puch AG was first published in 1984 and describes a connecting point between an upper part and a lower part, which comprises the manual crank drive, of a bicycle frame. Said document claims an interface which optionally has the design either of a conventional rigid frame structure or of a frame structure with spring-mounted rear wheel swingarm. For this purpose, a downtube and seat tube are fixedly connected to a connecting part and form an upper assembly. To obtain a rigid bicycle frame, said upper assembly is fixedly pinned and screwed to a lower assembly. To obtain a spring-mounted rear wheel swingarm, an additional assembly with a rubber support spring is incorporated at the connecting point.

WO09079901 from Foster Assets Co. Ltd. was first published in 2008 and describes a drive module for a bicycle with auxiliary drive, which drive module is in the form of a central part of the frame structure. The central drive module is composed of a direct-current motor, a battery unit, a gearing unit and a module for motor control. The battery unit is accommodated in a sealed housing, which need not imperatively be arranged in the spatial vicinity of the other parts of the drive. Different spatial orientations for the mounting of the drive module permit installation in bicycles with different frame shapes and different modes of operation. The drive is imparted via a conventional chain drive.

EP2287065 (or US2011042156) from Fairly Bike Manufacturing Co. Ltd. was first published in 2011 and describes the concept of a bicycle with auxiliary drive, in which, in particular, the battery unit for the drive and further electronic components are accommodated in a special large-volume saddle tube of the frame. For this purpose, the electronic components are arranged in a battery housing which can be removed from the saddle tube and which simultaneously also serves for receiving, and for the height adjustment and fastening of, the saddle support.

EP2230164 (or US2010237585) from Thömus Veloshop was first published in 2010 and describes a bicycle frame in which a battery unit suitable for an auxiliary drive can be accommodated in protective fashion in the downtube. For this purpose, the downtube has a tube section with a closable opening through which a battery unit can be inserted into or removed from the tube section in a simple manner. A drive motor is integrated into a rear wheel.

DE202004014189 from Reinhold Gruber was first published in 2004 and presents a bicycle having an auxiliary drive, wherein a motor and gearing are integrated together with a mounting adapter in the normal saddle tube. The drive torque of the motor is transmitted within the frame directly to the pedal crank axle in the region of the pedal crank bearing.

DE19840576 from SRAM Deutschland GmbH was first published in 2000 and describes an encapsulated drive module for a bicycle. The drive module is composed of a chain case which is formed as a load-bearing part of the frame structure and which can be closed off by means of a cover. Situated in the interior of said chain case are components for transmitting power from the pedal crank bearing to the hub of the rear wheel, a locking mechanism and actuating cables for a brake device and for the switching of a multi-gear hub. The drive module constitutes the only part of the rear frame structure. In particular, the otherwise conventional downtube structure is dispensed with on the other side of the rear wheel, such that the described drive module serves as a unilateral support for the hub of the rear wheel. The drive module is connected to the front part of the bicycle frame by way of an easily releasable connecting point arranged outside the encapsulated housing.

EP1188659 from Honda Motor Co. Ltd. was first published in 2002 and presents a collapsible bicycle with auxiliary drive. The hub of the rear wheel is fastened on both sides to a two-part rear section of the frame structure. These are connected to one another by screw connections. The rear section of the frame structure is releasably connected to the front frame structure in a simple manner by a type of hinge. The saddle tube is fastened directly to the rear part of the frame structure by clamping means, wherein a conventional saddle tube is not provided. The battery unit is fastened between the two parts of the rear frame structure, whereas the other components of the drive are arranged therebelow.

### SUMMARY OF THE INVENTION

It is an object of the invention to specify an improved drive device for a bicycle.

Said object is achieved by means of the drive device defined in the patent claims.

An embodiment of the invention is based on a drive device which serves as a central unit and which is suitable for the construction of a wide variety of bicycle concepts. The drive device according to the invention generally represents the load-bearing and functional central element of the bicycle, in effect simultaneously the body and the core of a bicycle. An embodiment of the drive device comprises, combined in a unipartite or multi-part housing, a pedal crank bearing, a gearing, a drive output, a pinion and a brake for the rear wheel. Furthermore, a possible auxiliary drive in the form of an electric drive, and associated assemblies, for example battery and/or controller, may be accommodated in the same housing or another housing. It is thus possible for the major technical functional elements of a bicycle to be integrated in the drive device.

In one embodiment, the central drive device has an entirely modular design and provides a uniform platform for the construction of, for example, a bike, a pedelec or electric bike in a wide range of variants. The main features of said central unit can be summarized as follows. The drive device serves as a robust support structure, preferably having, on both sides, two half-shells (swingarms) as a load-bearing composite structure. Depending on the embodiment, the drive device comprises a rigid or spring-mounted rear wheel swingarm. This may be mounted in pendular fashion for example about the pedal crank bearing axle and supported with respect to the frame by means of a spring element. In a preferred embodiment, use is made of a continuously variable gearing which is arranged in the region of the pedal crank bearing or of the hub and which ensures an optimum transmission of power. Good results can be achieved with a continuously variable gearing with toothed-belt drive output and worm gear set for the auxiliary motor. A torque sensor may for example be operatively connected to the drive axle of the pedal crank bearing and serve for the control of an activatable auxiliary drive via a freewheel. A functional end section for belt pulley and a rear wheel brake are advantageously integrated into the swingarm for the rear wheel. The mounting of the rear wheel is advantageously realized by way of a specially designed quick-release axle. The drive device according to the invention makes it possible to realize a fully encapsulated design which is protected against vandalism and which ensures a long service life.

In a preferred embodiment, a central element serves as load-bearing structure (support structure). The support structure generally serves for the operative connection of the drive device to the rest of the frame structure (front-end section or rear-end section respectively) of the bicycle, and may be designed differently depending on the field of use. The support structure is for example designed as a deformed part composed of aluminum or as a fiber-reinforced plastics part. The junction points with respect to the peripheral parts of the front-end section and of the rear-end section of the bicycle are in the form of flexurally and torsionally rigid connections. If required, the connections may be designed to be releasable. The operative connection between the support structure and the drive device is preferably realized by way of a standardized, easily releasable interface. In particular in the case of a fleet of vehicles such as is encountered for example at a bicycle hire business, this makes it possible for the maintenance outlay and downtime of individual bicycles to be reduced significantly.

In one embodiment, by way of the gearing housing that is operatively connected in positively locking and non-positively locking fashion to the support structure, swingarms (for example aluminum deformed parts, CFRP parts) in the form of load-bearing molded parts are arranged on both sides of the gearing housing. Said connection may be in rigid form or else may also for example involve a pendular mounting about the pedal crank bearing axle. It is accordingly possible to realize a bicycle with a spring-mounted rear wheel swingarm. A damping element may be arranged in and/or on the saddle tube and serve for the resilient support of the swingarm with respect to the rest of the frame.

In one embodiment, there is integrated into the pedal crank bearing axle a torque sensor that identifies when and with what intensity the pedals are operated. The activation and deactivation of the electric motor is controlled by means of a correspondingly parameterizable controller. The motor is generally deactivated at a speed of 25 km/h. Exceptions to this are variants of more powerful electric bikes, which however require corresponding certification as small motorcycles.

In one variant, use is made of a special pedal crank bearing gearing. The transmission of power takes place via a special oil utilizing the so-called “elasto-hydrodynamic” effect. An advantage consists in that, under normal circumstances, there is no direct metallic contact between the power-transmitting mechanical parts, and that the gearing is thus lubricated, and requires no maintenance, over its entire service life. In the case of this gearing, a single ball is arranged between two conical disks that are rotatable about a respective axis. The transmission ratio can be varied by adjusting the ball. The adjustment of the ball is performed for example by way of an internally arranged slide which is operatively connected via a Bowden cable to a twist grip shift means mounted on a handlebar. If required, an actuating motor may be used instead of the manual adjustment. Other actuation means are possible.

In one embodiment, the drive device has an activatable, preferably brushless drive. This typically has a power of between 250 and 500 W. Good results are obtained with integrated, insulated 36 V battery packs designed for temperature ranges from −25° C. to +85° C. If required, the batteries may be insulated and/or pre-heated by way of a special heater.

In one embodiment, use is made of an electronic printed circuit board with a processor for controlling functions available on the bike. Said electronic printed circuit board may for example control or regulate the motor management and drive output management and the safety equipment. If required, a GSM modem and a GPS receiver may be provided, which serve for localization, recording and transmission of position and operating data, etc. In particular in the case of rental systems, it is thus possible to obtain an overview of the fleet.

A front-end section that can be connected to the drive device generally has a downtube and a steering tube. These are for example in the form of a forged part with plug-in points for hydraulics Bowden cables and electrics. Depending on the field of use, use is made of a fork that is likewise equipped with integrated lines. Good results are obtained with 26″ wheels and standard components such as a hub dynamo and roller brake. Other design variants are possible. Front-end structure with integrated illumination device and handlebar design vandalism-proof with simple height adjustment for bike sharing systems; optionally with steering dampers, brake levers, twist grip shift or electric bike drive control; integration of multi-function display for monitoring and for parameterization, adaptation respectively for analysis during servicing.

A rear-end section that can be operatively connected to a drive device may have the following design. A saddle tube may be configured as a special molded part with integrated plug-in points for electrics, rear light and different saddle variants. If required, a post with simple height adjustment, for example gas-pressure suspension, or optionally with automated height adjustment by customer keycard (integrated toothed rack drive), may be implemented. The rear wheel is advantageously in the form of a 26″ wheel. A specially designed hub with a quick-release axle makes it possible for the wheel to be exchanged without intervening in the technology of the drive device.

If required, connections for mudguards and/or stands and/or luggage support systems may be provided. In one embodiment for rental bicycles, a docking ball for a lock system may be provided. Said docking ball may be configured so as to lock by way of locking pins that project laterally out of the ball and which are arrested in lateral openings on the station. In the frame there may be provided an integrated cable lock system which has an RFID key head (the RFID key head must be stowed in the key quiver of the ball upon handover).

An embodiment of the invention comprises a drive device for a bicycle. The drive device has a central housing to which at least one swingarm is laterally attached. Said swingarm serves for holding a wheel which about a first axis (axis of rotation). The at least one swingarm serves for accommodating at least one drive means. The central housing may serve for accommodating a gearing. A swingarm may be arranged on each side of the housing. Each of the two swingarms has a flange which is rotatable about the axis of rotation and which serves for accommodating a hub of a wheel. The hub may have first operative connection means which run perpendicular to the axial direction and which interact with correspondingly designed second operative connection means. The operative connection means may serve for the transmission of the drive and braking torques. The first operative connection means may for example be grooves, and the second operative connection means may for example be pegs. An electric motor may be arranged at least in regions in the interior of a swingarm. A gearing may be arranged in the central housing. The gearing may be a continuously variable gearing having a ball which, for power transmission, is clamped adjustably between two disks (flat disks or conical disks or pot-shaped disks) which are rotatable about a respective axis. The central housing may be operatively connectable by way of a standardized interface to a support structure. In certain embodiments, the central housing may be integrated into the support structure. The at least one swingarm may be deflectable relative to the support structure about a second axis counter to the force of a spring arrangement.

### BRIEF DESCRIPTION OF THE DRAWINGS

Aspects of the invention will be explained in more detail on the basis of the exemplary embodiments shown in the following figures and the associated description. In the figures:

FIG. 1 shows a drive device according to the invention in a perspective illustration obliquely from the rear and above.

FIG. 2 shows the drive device as per FIG. 1 in a perspective illustration obliquely from the rear and above with a wheel dismounted.

FIG. 3 shows a detail A as per FIG. 2 in an enlarged illustration.

FIG. 4 shows the drive device as per FIG. 1 in an exploded illustration.

FIG. 5 shows the drive device as per FIG. 1 in partially exploded form obliquely from front left and above.

FIG. 6 shows the drive device as per FIG. 1 in partially exploded form obliquely from front right and above.

FIG. 7 shows a mountain bike having a drive device according to the invention obliquely from the front and above.

FIG. 8 shows a city bike having a drive device according to the invention obliquely from the front and above.

FIG. 9 shows a tandem having a drive device according to the invention obliquely from the front and above.

FIG. 10 shows a three-wheeled cargo bicycle having a drive device according to the invention obliquely from the front and above.

FIG. 11 shows a bicycle for passenger transport having a drive device according to the invention obliquely from the front and above.

FIG. 12 shows a second variant of a vehicle for transporting passengers and/or goods.

FIG. 13 shows a further embodiment of a drive device with a lock.

FIG. 14 shows detail B as per FIG. 13.

### DETAILED DESCRIPTION OF THE INVENTION

In the following figures, parts of identical function are denoted by the same reference signs.

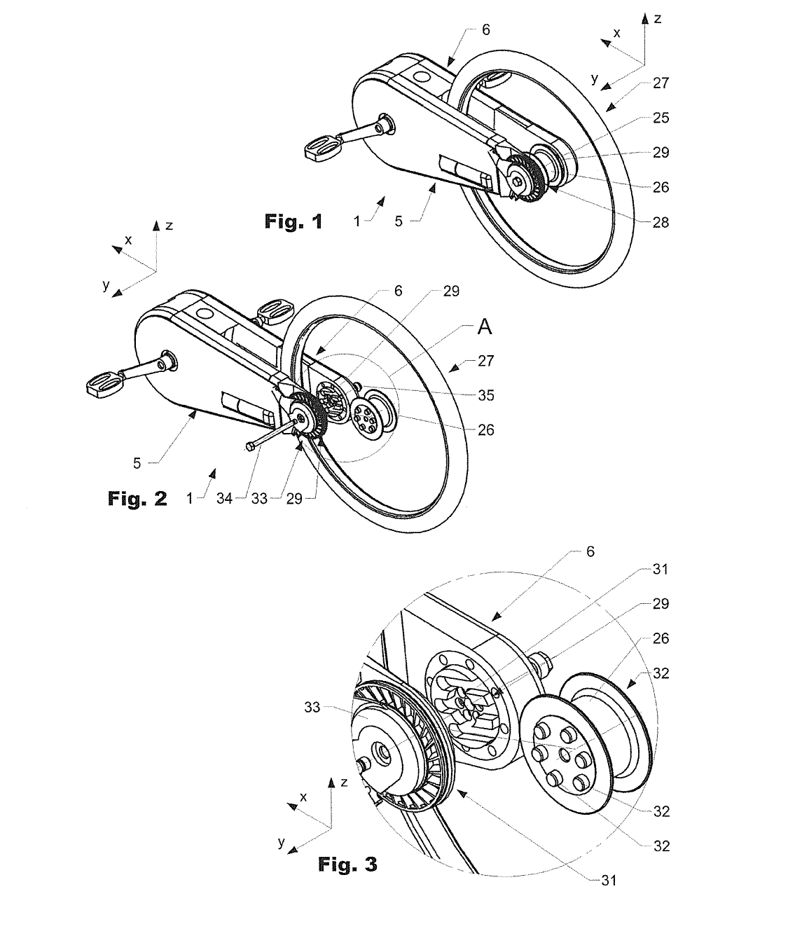

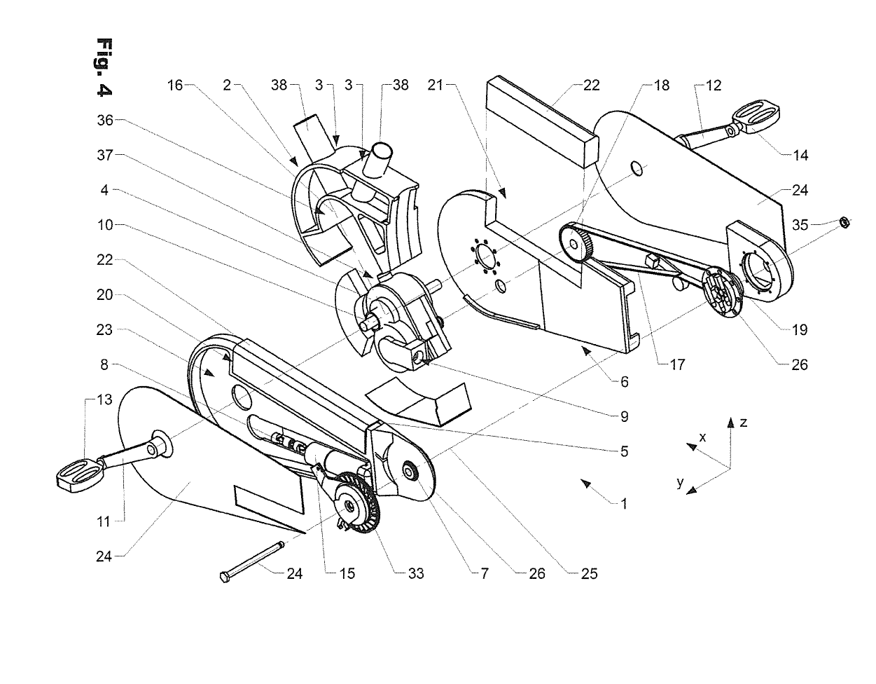

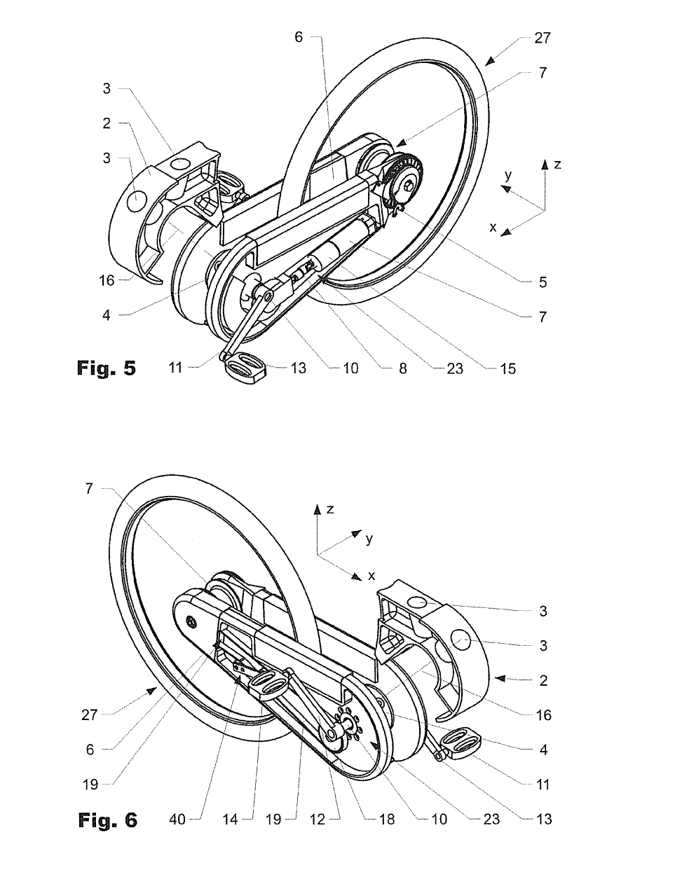

FIG. 1 shows an embodiment of a drive device 1 according to the invention in a perspective illustration obliquely from the rear and above, with a wheel 27 mounted thereon. FIG. 2 shows the drive device 1 in a perspective illustration obliquely from the rear and above, in which the wheel 27 is illustrated in a dismounted position. FIG. 3 shows detail A from FIG. 1 in an enlarged illustration. FIG. 4 shows the drive device 1 in an exploded illustration. FIG. 5 shows the drive device in partially exploded form obliquely from front left and above, and FIG. 6 shows the same obliquely from front right and above.

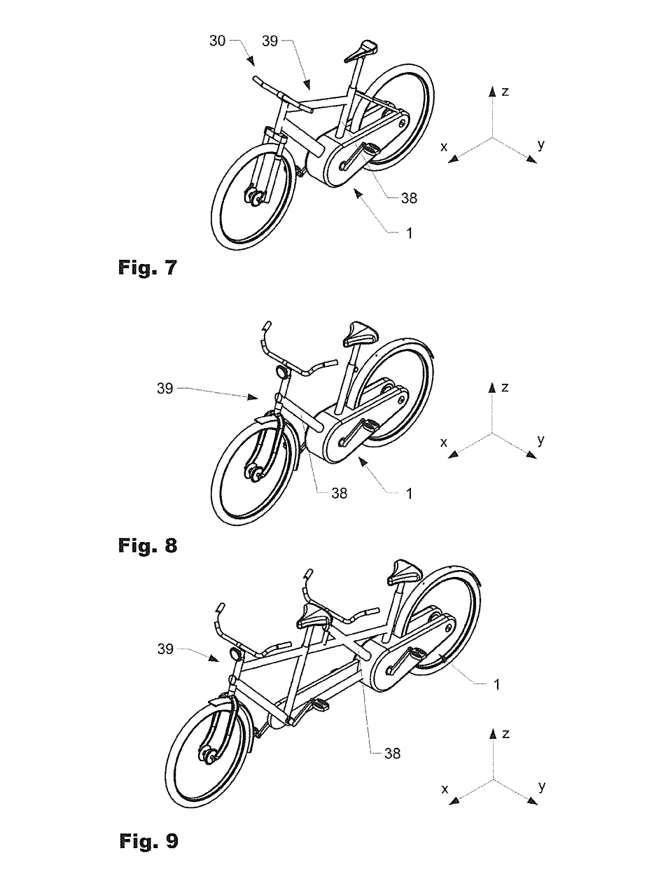

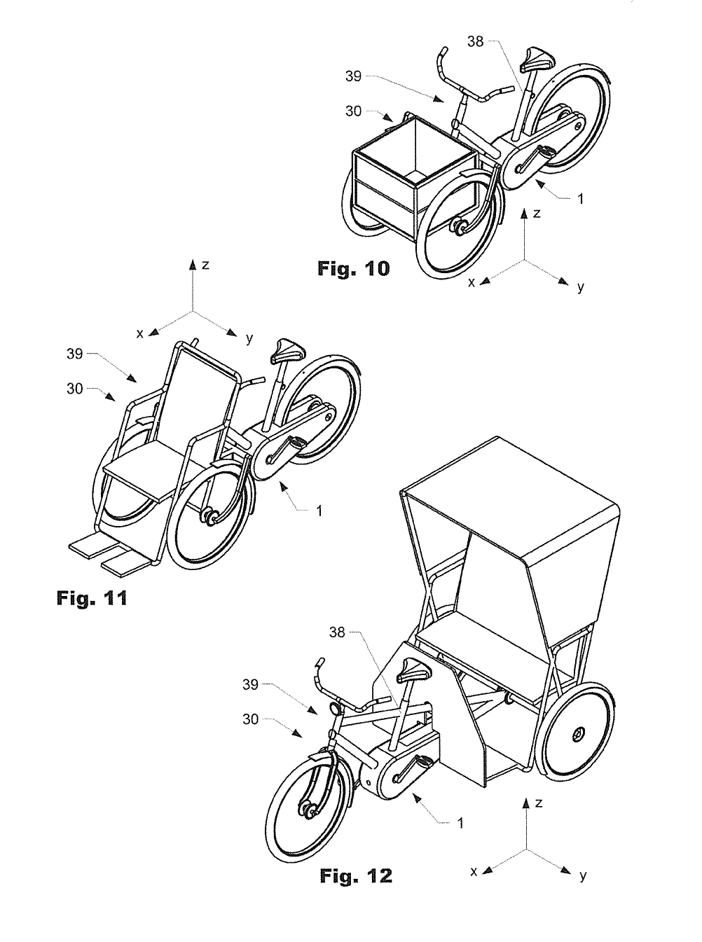

As can be seen inter alia in FIG. 4, the drive device 1 is of modular construction. In the assembled state, the drive device 1 interacts via standardized interfaces 36, 37 with a support structure 2 arranged on a frame, which support structure serves for the transmission and exchange of the forces that arise during operation with the rest of the frame 39 of the bicycle 30 (cf. the examples as per FIGS. 7-12). The support structure 2 is preferably a component produced from aluminum or fiber-reinforced plastic or some other suitable material. The support structure 2 has connectors 3 for tubes 38 of one or more different bicycle frames 39 (cf. FIGS. 7-12). As illustrated in FIGS. 7-12, the drive device 1 is suitable for the construction of different bicycles. The support structure 2 may be configured and dimensioned differently depending on the field of use.

The drive device 1 has a central housing 4 (cf. FIG. 4) which may have a gearing (not illustrated in any more detail), preferably a continuously variable gearing. If required, a gearing may be accommodated in a separate housing. In the embodiment shown, a left-hand and a right-hand swingarm 5, 6 are operatively connected to the central housing 4. Said swingarms are in the form of bending members and serve, at one side, for holding a hub 26 which is arranged so as to be rotatable about an axis 25 and which serves for holding the rear wheel 27. In the embodiment shown, the swingarms 5, 6 have an open cross section and serve for accommodating various further assemblies of the drive device 1. As viewed in the longitudinal direction (x direction), the cross section of the structurally supporting part of the swingarms 5, 6 is of substantially C-shaped form at least in regions and, during operation, is closed off by covers 24. The covers 24 may be part of the supporting structure.

As can be seen in FIGS. 1-3, the hub 26 of the wheel 27 is held by a first and a second flange 28, 29. The flanges 28, 29 are arranged on the swingarms 5, 6 coaxially opposite one another so as to be mounted rotatably about the axis of rotation 25. In the embodiment shown, said flanges have a special design which makes it possible for the hub 26, or the wheel 27, to be slid in between these from the side. The flanges 28, 29 have grooves 31 which are arranged perpendicular to the axis of rotation 25 and which are configured so as to correspond to pegs 32 of the hub 26. This construction firstly makes it possible for the wheel 26 to be potentially slid in between the hubs 28, 29 from the side. Furthermore, the grooves 31 and the pegs 32 serve for transmitting the torque of the toothed belt 17. On the opposite side, the grooves 31 and the peg 32 serve for transmitting a braking torque which, in the embodiment shown, is generated by a brake 33 that is operatively connected to the first swingarm 5. The brake 33 is in this case a commercially available brake system (for example roller brake from Shimano). Other brake systems may be used if required. The hub 26 is fixed between the two flanges 28, 29 by a fastening screw 34 which is passed through the flanges 28, 29 and the hub 26 and which is screwed tight on the other side by way of a fastening nut. Other fastening means, for example a quick-release clamp, may be used if required.

In the embodiment shown, there is accommodated in the left-hand swingarm 5 a motor 7 which is installed in the longitudinal direction and which is operatively connected, via an articulated shaft 8 and a pinion 9, to the gearing (not illustrated in any more detail) arranged in the interior of the housing 4. As can be seen from FIG. 5, the motor 7 may if required be operatively connected to a further reduction gearing 15 and integrated into the swingarm 5, in order that the motor rotational speed can be adjusted to an optimum value. Good results are obtained with an output of 60-70 revolutions per minute.

The gearing is furthermore operatively connected to a crankshaft 10 which projects beyond the housing 4 on both sides. The crankshaft 10 serves for holding a left-hand and a right-hand pedal crank 11, 12 and a left-hand and a right-hand pedal 13, 14 by means of which a bicycle can be driven manually in the conventional way with and/or without assistance from the motor 7. If required, the drive may also be configured so as to have no manual drive. In this case, the bicycle is driven purely electrically. Footrests may be provided instead of cranks and pedals.

FIGS. 5 and 6 illustrate the support structure 2 separate from the drive device 1. The support structure 2 is shown obliquely in front of and above the drive device 1. The mounting direction is schematically indicated by a dashed line 16. As can be seen, in the embodiment shown, the drive device 1 can be released from the support structure 2 in a simple manner. This represents a considerable advantage in terms of maintenance in particular in the case of bicycles that are used by rental businesses, because the components can be exchanged in a simple manner. The support structure has in this case a curved design which is coordinated with the shape of the housing 4 and engages partially around the latter. Other embodiments are possible. The support structure 2 is operatively connected to the housing 4 and/or to at least one swingarm 5, 6 by fastening means (not illustrated in any more detail).

As can be seen in FIG. 6, a toothed belt 17 is arranged in the right-hand swingarm 6, by means of which toothed belt the gearing that is accommodated in the housing 4 is operatively connected by way of a first toothed belt pulley 18 to a second toothed belt pulley 19, said toothed belt thus transmitting the drive power from the gearing to the wheel 27. In the embodiment shown, the toothed belt is tensioned by a tensioning device 40 which, in this case, is formed by a roller that can be deflected counter to the force of a spring.

The swingarms 5, 6 are produced as load-bearing parts. Depending on the field of use, they may be produced from aluminum, fiber-reinforced plastic or some other suitable material. In a further embodiment, they are produced from bent tubing or tube sections which are connected to one another via flanges (not illustrated in any more detail). In a further embodiment, only one swingarm is provided, in which the parts of the opposite swingarm are likewise integrated.

In the embodiment shown, each swingarm has a respective compartment 20, 21 which is suitable for example for accommodating a battery 22, which in this case can be inserted from above. Other arrangements are possible. As can be seen inter alia in FIG. 4, the swingarms 5, 6 have a respective cavity 23 in which the drive means 7, 8, 17, 18, 19 are accommodated. Said cavities 23 may be closed by means of covers 24 (cf. FIGS. 1-3 and 4). The cavities 23 may be subdivided further if required.

As can be seen inter alia in FIG. 4, the swingarms 5, 6 and the support structure are advantageously designed such that, during the production process, they can be easily demolded in one direction (in this case y direction), and undercuts are as far as possible avoided. This has a positive effect in reducing production costs.

FIGS. 7-12 show different bicycles and transportation means 30 which all have a drive device 1 according to the invention. The drive device 1 may be of spring-mounted configuration, wherein the swingarms are mounted so as to be movable relative to the housing 4, or relative to the support structure 2, about an axis of rotation (y axis) counter to the force of a spring arrangement. In principle, the drive device 1 is also suitable for the construction of vehicles having more than two, or three, wheels. For example, two drive devices 1 of spring-mounted configuration may be used in the case of a four-wheeled transportation means.

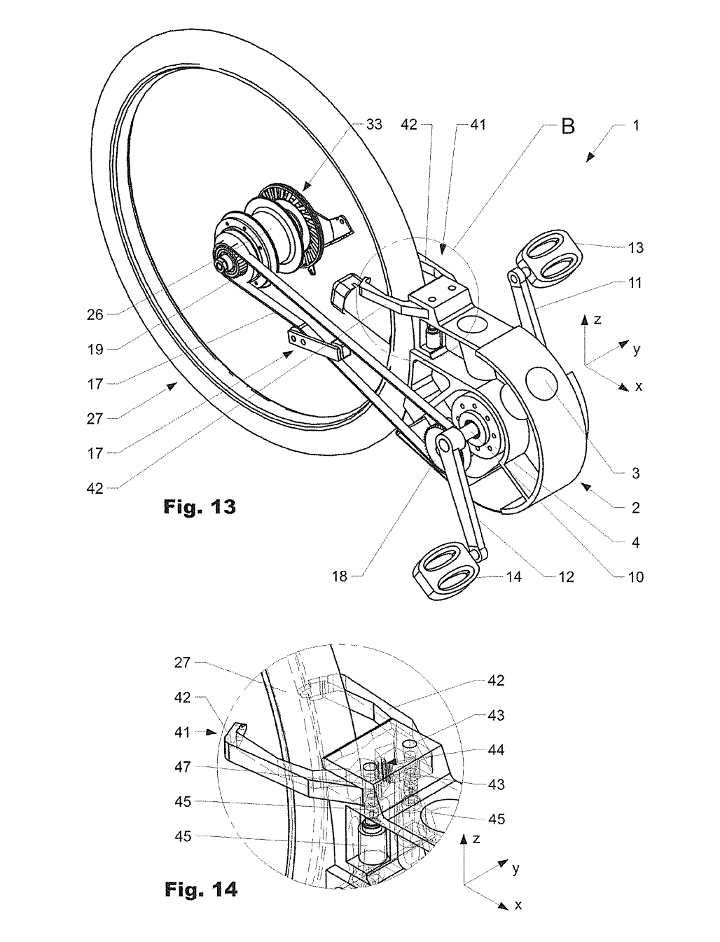

FIG. 13 shows a further embodiment of a drive device 1 in a perspective illustration obliquely from the front and above. Certain parts, in particular the swingarms, have been omitted so as to provide a view of the internals of the drive device 1. By contrast to the variants described above, the drive device has a lock 41 which, in this case, is integrated into the support structure 2. The electromechanical lock 41 has two jaws 42 which, in the locked position, engage around and thus block the wheel 27. FIG. 14 schematically shows detail B as per FIG. 13 in an enlarged illustration. To provide a better view of the structure, the edges that are not inherently visible are illustrated by dashed lines. Each of the two jaws 42 is arranged rotatably about a bearing journal 43. Each of the two jaws 42 has an internally arranged toothing 44, said toothings engaging into one another and thus realizing mutual coordination of the movement of the two jaws. In the embodiment shown, the two jaws are driven, and the locking is performed, by way of actuators 45 (for example actuating motors) which are arranged in the interior of the support structure 2 and which, in the locked position, engage by way of locking pins 46 into locking openings 47 of the jaws 42 and thus lock the latter. During the unlocking process, the locking pins 43 are pulled out of the locking openings 47 such that the jaws 42 are released and open for example under the action of a spring (not illustrated in any more detail), such that the wheel 27 is unlocked. The lock 41 that is shown may also be combined, if required, with other bicycle frames. The lock 41 is preferably locked and unlocked by way of a controller that is preferably integrated into the drive box 1.

1. A drive device (1) for a bicycle comprising:
a central housing (4) to which there is laterally attached at least one swingarm (5, 6) holding a wheel (7) which is arranged so as to be rotatable about a first axis (25), and wherein the at least one swingarm (5, 6) accommodates at least one drive means (7, 8, 17, 18, 19).

2. The drive device (1) as claimed in claim 1, wherein the central housing (4) accommodates a gearing.

3. The drive device (1) as claimed in claim 1, wherein a swingarm (5, 6) is arranged on both sides of the housing (4), and in that each of the two swingarms includes a flange (28, 29) which is rotatable about the axis of rotation (25) and which receives the wheel (27).

4. The drive device (1) as claimed in claim 3, wherein the flanges (28, 29) include first operative connection means (31) which, in an assembled state, interact with correspondingly designed second operative connection means (32) on a hub (26).

5. The drive device (1) as claimed in claim 4, wherein the first operative connection means are grooves (31), and the second operative connection means (32) are pegs.

6. The drive device (1) as claimed in claim 1, further comprising an electric motor is arranged in at least one swingarm (5, 6).

7. The drive device (1) as claimed in claim 1, wherein a gearing is arranged in the central housing (4).

8. The drive device (1) as claimed in claim 2, wherein the gearing comprises a continuously variable gearing having a ball which, for power transmission, is clamped adjustably between two disks which are rotatable about a respective axis.

9. The drive device (1) as claimed in claim 1, wherein the central housing (4) is connected by a standardized interface (36, 37) to a support structure (2).

10. The drive device (1) as claimed in claim 1, wherein the central housing (4) is integrated into the support structure (2).

11. The drive device (1) as claimed in claim 1, wherein the at least one swingarm (5, 6) is deflected relative to the support structure (2) about a second axis counter to the force of a spring arrangement.

12. A bicycle (30) having a drive device (1) as claimed in claim 1.
